(19) United States
(12) Patent Application Publication
(10) Pub. No.: US 2019/0349615 A1
(43) Pub. Date: Nov. 14, 2019

(54) HANDLING ADVERTISEMENT PLACEMENT WITHIN A DECISIONED ADVERTISEMENT

(71) Applicant: ARRIS Enterprises LLC, Suwanee, GA (US)

(72) Inventors: Matthew A. Milford, Waxhaw, NC (US); Srinivasa R. Akkala, Bellingham, MA (US); Jacqueline Ann Luppi, San Carlos, CA (US); David A. Romrell, Hillsboro, OR (US)

(21) Appl. No.: 16/408,604

(22) Filed: May 10, 2019

Related U.S. Application Data
(60) Provisional application No. 62/670,232, filed on May 11, 2018.

(51) Int. Cl. H04N 21/234; H04N 21/81; H04N 21/2365; H04N 21/2662

(52) U.S. Cl. CPC H04N 21/23424; H04N 21/812; H04N 21/23412; H04N 21/2662; H04N 21/23655

(57) ABSTRACT

A system is provided for use with a source content provider, a first database and a second database where the source content provider is able to provide source content data having a placement opportunity start identifier for an insert position for primary advertisement data and a placement opportunity stop identifier for an end position for the primary advertisement data. The first database has first advertisement data and second advertisement data, wherein one of the first advertisement data and the second advertisement data is to be inserted between the insert position and the end position. The first advertisement data has a second placement opportunity start identifier for a second insert position for nested advertisement data and a second placement opportunity stop identifier for a second end position for the nested advertisement data. The second database has the third advertisement data to be inserted between the second insert position and the second end position.

The present application claims priority from U.S. Provisional Application No. 62/670,232 filed May 11, 2018, the entire disclosure of which is incorporated herein by reference.

### BACKGROUND

Embodiments of the invention relate to content delivery systems that provide content with advertisements spliced into the content.

### SUMMARY

Aspects of the present invention are drawn to a system for use with a source content provider, a first database and a second database. The source content provider is able to provide source content data having a placement opportunity start identifier for an insert position for primary advertisement data and a placement opportunity stop identifier for an end position for the primary advertisement data. The first database has first advertisement data and second advertisement data, wherein one of the first advertisement data and the second advertisement data is to be inserted between the insert position and the end position. The first advertisement data has a second placement opportunity start identifier for a second insert position for nested advertisement data and a second placement opportunity stop identifier for a second end position for the nested advertisement data. The second database has the third advertisement data to be inserted between the second insert position and the second end position. The system includes a communication component, an advertisement management component, a nested advertisement determining component, a splicer and a manifest delivery controller. The communication component is able to receive the source content data. The advertisement management component is able to obtain one of the first advertisement data and the second advertisement data as obtained advertisement data. The nested advertisement determining component is able to determine whether the obtained advertisement data includes the second placement opportunity start identifier and the second placement opportunity stop identifier. The manifest delivery controller is able to assemble a manifest. Wherein when the nested advertisement determining component determines that the obtained advertisement data includes the second placement opportunity start identifier and the second placement opportunity stop identifier, the advertisement management component is further operable to obtain the third advertisement data as nested advertisement data. The splicer is able to generate output data comprising the source content data, the first advertisement data, the third advertisement data and the manifest. Wherein the manifest includes information indicating a first starting point of the first advertisement data and second starting point of the third advertisement data within the output data.

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1 illustrates a prior art content delivery system;

FIG. 2 illustrates an exploded view of the prior art content service provider of FIG. 1;

FIG. 3A illustrates a prior art stream of content and a space for advertisement data;

FIG. 3B illustrates a prior art stream of content and advertisement data;

FIG. 4 illustrates a content delivery system in accordance with aspects of the present disclosure;

FIG. 5 illustrates method of delivering content and advertisement data in accordance with aspects of the present disclosure;

FIG. 6A-6C illustrate exploded views of the content service provider of FIG. 4 in an instance where the advertisement data is not nested;

FIG. 7 illustrates an exploded view of the advertisement repository for the content delivery system of FIG. 4;

FIG. 8A illustrates a stream of content, primary advertisement data and a space for nested advertisement data, in accordance with aspects of the present disclosure; and

FIG. 8B illustrates a stream of content, primary advertisement data and nested advertisement data, in accordance with aspects of the present disclosure.

### DETAILED DESCRIPTION

A source content provider may want to deliver localized content direct to its subscribers. The content is created as a set of recorded files captured from different sources, i.e. video data, news data, sports data, traffic data, etc. These files are then spliced into custom manifests by a manifest delivery controller (MDC), which treats each piece of content as a new advertisement request. However, in order to monetize the content, source content provider may want to add advertisements to the content. This would effectively be adding advertisements to advertisements, since each piece of content is treated like an advertisement from the MDC's perspective. However, advertisements do not have advertisements, by the very nature of an advertisement. An advertisement is atomic in the sense that it plays out in its entirety.

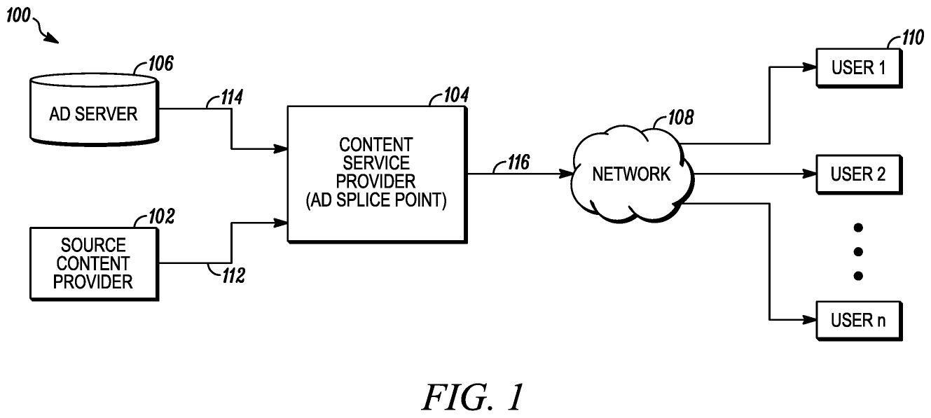

A prior art system for providing content with advertisements will now be described in greater detail with reference to FIGS. 1-3B.

FIG. 1 illustrates a prior art content delivery system 100.

As shown in the figure, content delivery system 100 includes a source content provider 102, a content service provider 104, an advertisement server 106, a network 108 and a plurality of end user devices 110.

Source content provider 102 is arranged to communicate with content service provider 104 via a communication channel 112. Content service provider 104 is additionally arranged to communicate with advertisement server 106 via a communication channel 114 and to communicate with the plurality of end user devices 110 via network 108 and a communication channel 116.

In operation, source content provider 102 provides source content to content service provider 104. The source content may be, for example, a movie or show that will ultimately be provided to the plurality of end user devices 110.

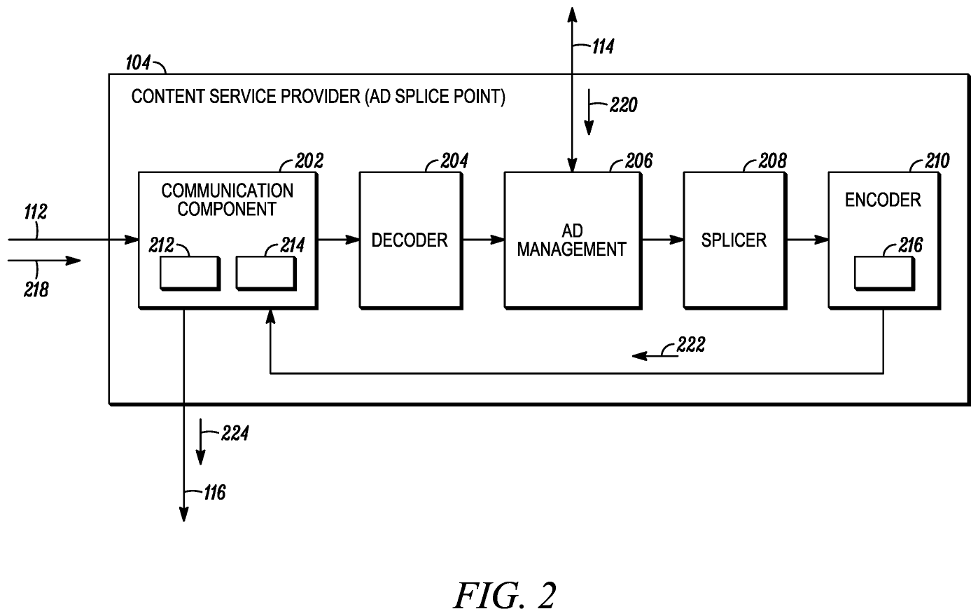

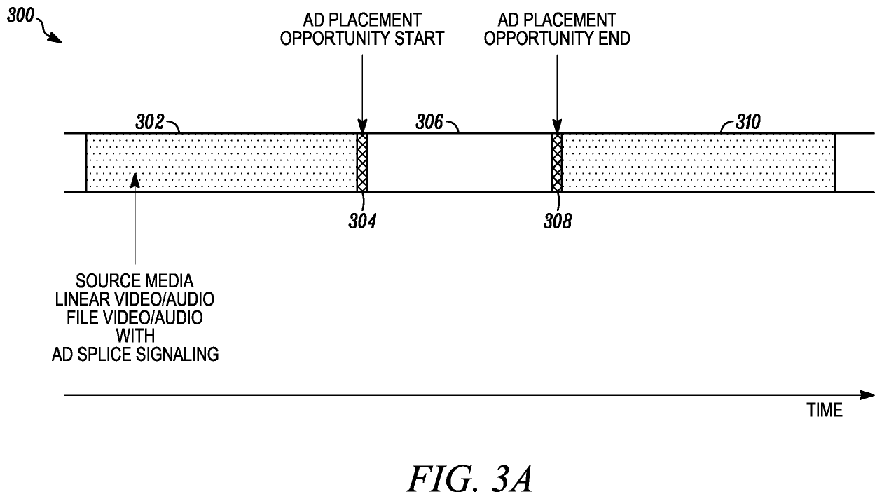

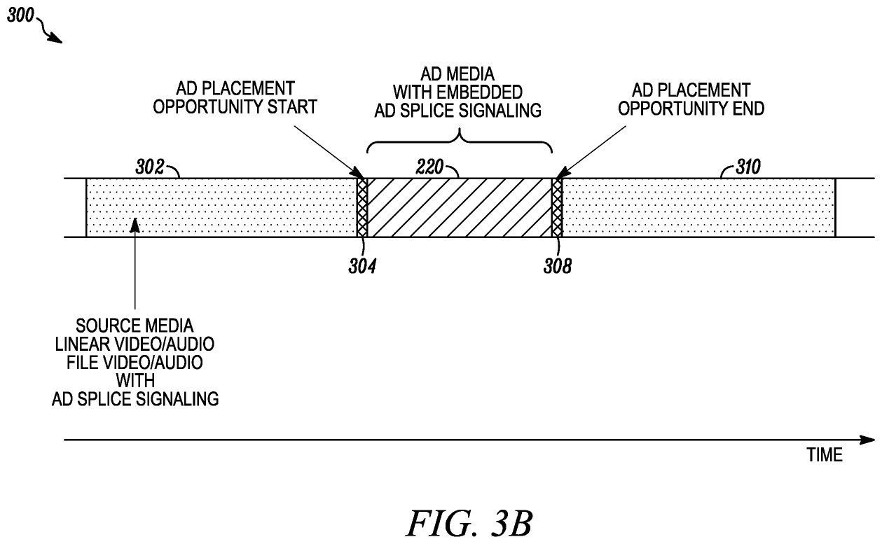

When content service provider 104 receives the source content, content service provider 104 may insert advertisements. This will be described in greater detail with reference to FIGS. 2-3A.

FIG. 2 illustrates an exploded view of content service provider 104 of content delivery system 100 of FIG. 1.

As shown in FIG. 2, content service provider 104 includes a communication component 202, a decoder 204, an advertisement management component (AMC) 206, a splicer 208 and an encoder 210. Communication component 202 includes a receiving component 212 and a transmitting component 214. Encoder 210 includes a manifest deliver controller (MDC) 216.

In operation, communication component 202 receives source content 218 via communication channel 112. In particular, receiving component 212 receives source content 218 via communication channel 112. This will be described in greater detail with reference to FIG. 3A.

FIG. 3A illustrates a prior art stream 300 of content and a space for advertisement data.

As shown in the figure, stream 300 includes a source media portion 302, an advertisement placement opportunity start identifier 304, an advertisement space 306, an advertisement placement opportunity stop identifier 308 and a source media portion 310.

Source media portion 302 and source media portion 310 include data associated with the content to be delivered to the plurality of end user devices 110. This may be for example audio/video data associated with a movie or show.

Advertisement placement opportunity start identifier 304 is a marker that will be used by splicer 208 to identify the start location within stream 300 for which advertisement data may be inserted. Similarly, advertisement placement opportunity stop identifier 308 is a marker that will be used by splicer 208 to identify the ending location within stream 300 for which advertisement data may be inserted.

Advertisement space 306 is space within stream 300 between advertisement placement opportunity start identifier 304 and advertisement placement opportunity stop identifier 308 into which advertisement data may be inserted.

Returning to FIG. 2, after receiving component 212 receives source content 218 via communication channel 112, source content 218 is provided to decoder 204 so as to identify advertisement placement opportunity start identifier 304 and advertisement placement opportunity stop identifier 308. The decoded source content 218 is then provided to AMC 206.

Returning to FIG. 1, AMC 206 accesses advertisement server 106 to obtain advertisement data, corresponding to an advertisement to be inserted into source content 218, from advertisement server 106.

Returning to FIG. 2, AMC 206 retrieves advertisement data 220 from advertisement server 106 and provides the decoded source content and advertisement data 220 to splicer 208. Splicer 208 then splices, i.e., inserts, advertisement data 220 into the decoded content data. This will be described in greater detail with reference to FIG. 3B.

FIG. 3B illustrates a prior art stream 300 of content and advertisement data.

As shown in the figure, stream 300 includes source media portion 302, advertisement placement opportunity start identifier 304, an advertisement portion 312, advertisement placement opportunity stop identifier 308 and source media portion 310.

As shown in FIG. 3B, splicer 208 has inserted advertisement data 220 into stream 300 in advertisement space 306 as shown in FIG. 3A. In particular, splicer 208 has inserted advertisement data 220 into stream 300 in between advertisement placement opportunity start identifier 304 and advertisement placement opportunity stop identifier 308.

Returning to FIG. 2, after splicer 208 has inserted advertisement data 220 into stream 300, the modified stream is provided to encoder 210. MDC 216 generates a manifest that identifies the locations of each “chunk” of data, which in this example, as shown in FIG. 3B, includes source media portion 302, advertisement portion 312 and source media portion 310.

Encoder 210 then generates an output stream 222 in the predetermined output encoding scheme, such as for example MPEG or ABR, wherein output stream 222 includes source media portion, advertisement portion 312, source media portion 310 and the newly generated manifest. Encoder 210 provides output stream 222 to communication component 202.

Receiving component 212 receives output stream 222 from encoder 210 and provides output stream 222 to transmitting component 214. Transmitting component 214 than provides an output signal 224 based on output stream 222. In particular, transmitting component 214 may provide further processing to output stream 222, such as for example filtering and amplifying, to generate output signal 224.

Output signal 224 is then provided to the plurality of end user devices 110 by way of communication channel 116 and network 108. In this example embodiment, output signal 224 includes a movie with an advertisement inserted therein.

In accordance with aspects of the present disclosure, advertisements are permitted to contain advertisements similar to media content, wherein a marker allows advertisements to play advertisements.

As mentioned above, prior art systems treat advertisements as atomic meaning there are no further decisions taken on the advertisement content. However, a system and method in accordance with aspects of the present disclosure opens up advertisements to decisions for additional use cases.

As opposed to treating advertisements as an asset to be inserted into other media content, aspects of the present disclosure include markers in advertisements so that their content can be inserted into other advertisements.

Consider, for example, a linear TV channel stream that contains Society of Cable Telecommunications Engineers (SCTE-35) markers indicating advertisement break locations. Typically, advertisements are spliced into the moving pictures experts group (MPEG) transport stream (TS) or adaptive bitrate (ABR) manifests and that advertisement insertion is complete. However, in accordance with aspects of the present disclosure, the advertisement media also contains SCTE-35 markers that need to be carried into the outbound stream/manifests as well. These splice points can then be used downstream by secondary level advertisement insertion systems to replace all or part of the primary level advertisement insertion.

Consider, for example, the use of national advertisements versus local/targeted advertisements. Suppose that a car manufacturer wants to insert nation-wide advertisements (content) into linear streams via HyperText Transfer Protocol Live Stream (HLS) markers but then also allow local advertisements (HLS Manifests with SCTE-35 annotations) to be stitched into the out bound manifests. This will enable downstream service providers to overlay a portion of the nation-wide advertisements from the car manufacturer with their own local sourced advertisements from local car dealerships. This carry through of SCTE-35 markers/ABR (HLS) annotations enable a secondary layer of advertisement insertions. In short, the present disclosure provides an advertisement splice point within advertisement media.

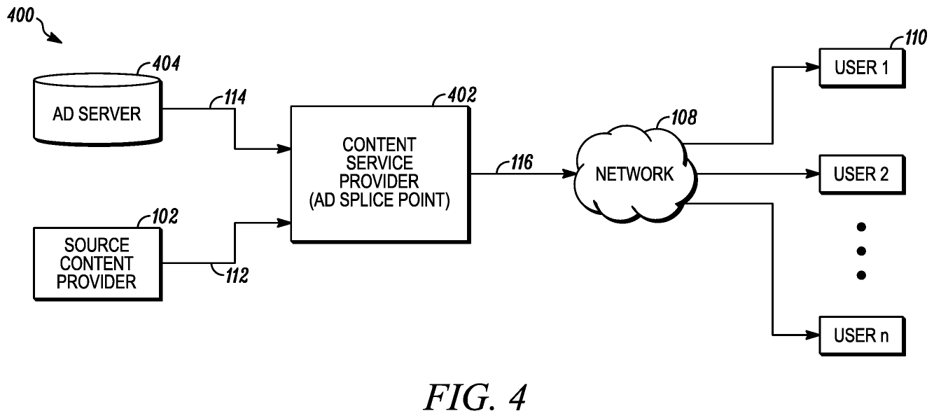

An example system and method for delivering content with nested advertisements in accordance with aspects of the present disclosure will now be described in greater detail with reference to FIGS. 4-8B.

FIG. 4 illustrates a content delivery system 400 in accordance with aspects of the present disclosure.

As shown in the figure, content delivery system 400 includes source content provider 102, a content service provider 402, an advertisement server 404, network 108 and plurality of end user devices 110.

Source content provider 102 is arranged to communicate with content service provider 402 via communication channel 112. Content service provider 402 is additionally arranged to communicate with advertisement server 404 via communication channel 114 and to communicate with the plurality of end user devices 110 via network 108 and communication channel 116.

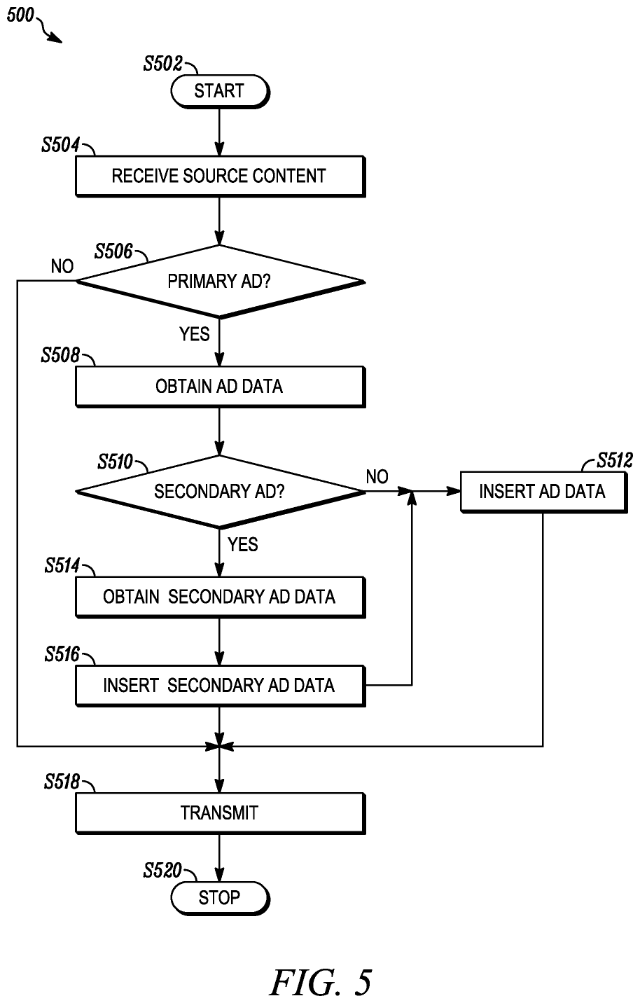

FIG. 5 illustrates method 500 of delivering content and advertisement data in accordance with aspects of the present disclosure.

As illustrated in the figure, method 500 starts (S502) and source content is received (S504). In an example embodiment, receiving component 212 receives the source content.

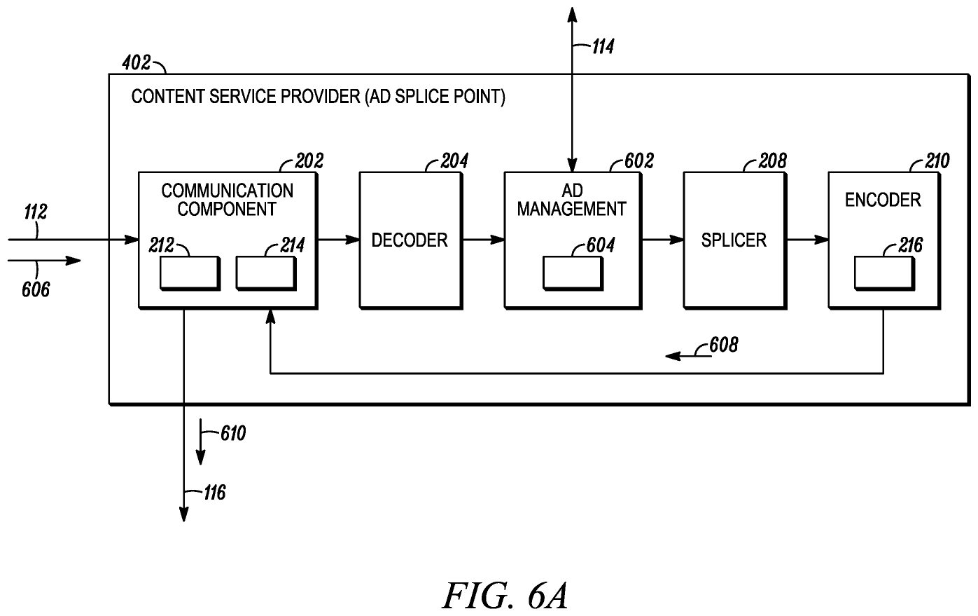

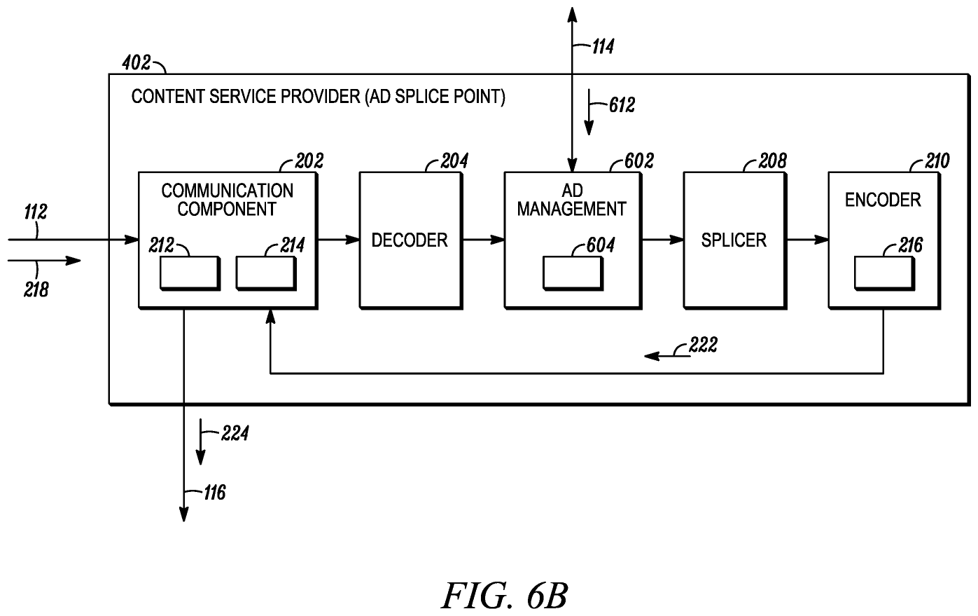

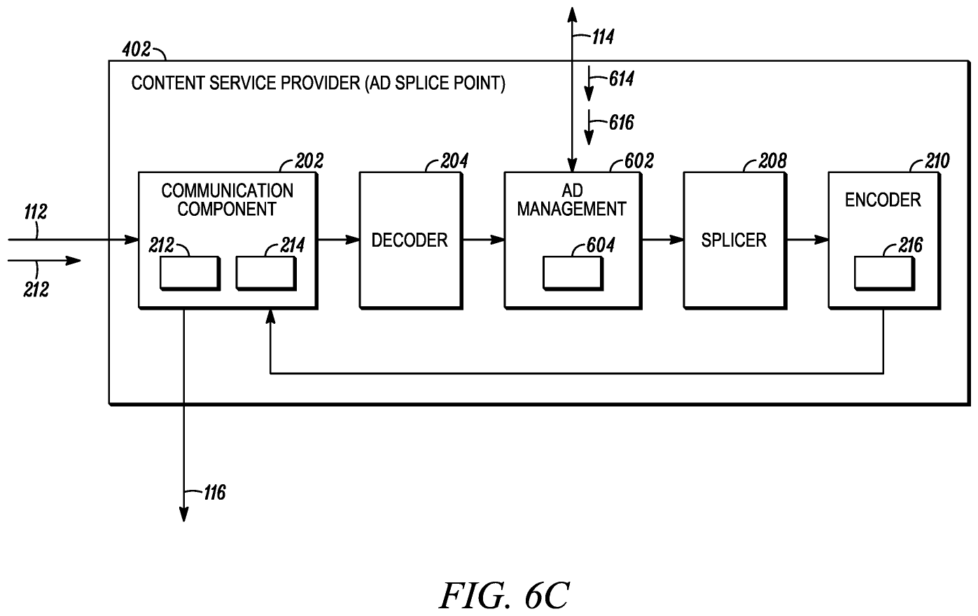

For example, returning to FIG. 4, content service provider 402 receives source content via communication channel 112. This will be described in greater detail with reference to FIG. 6A.

FIG. 6A illustrates an exploded view of content service provider 402 of FIG. 4 in an instance where the advertisement data is not nested.

As shown in FIG. 6A, content service provider 402 includes communication component 202, decoder 204, an advertisement management component (AMC) 602, splicer 208 and encoder 210. AMC 602 includes a nested advertisement determining (NAD) component 604.

In this example, communication component 202, decoder 204, AMC 602, splicer 208 and encoder 210 are illustrated as individual devices. However, in some embodiments, at least two of communication component 202, decoder 204, AMC 602, splicer 208 and encoder 210 may be combined as a unitary device. Further, in some embodiments, at least one of communication component 202, decoder 204, AMC 602, splicer 208 and encoder 210 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from, and write information to the tangible computer-readable media. In the alternative, the tangible computer-readable media may be integral to the processor. The processor and the tangible computer-readable media may reside in an application specific integrated circuit (“ASIC”). In the alternative, the processor and the tangible computer-readable media may reside as discrete components.

Example tangible computer-readable media may be also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein.

The OSI model includes seven independent protocol layers: (1) Layer 1, the physical layer, which defines electrical and physical specifications for devices, and the relationship between a device and a transmission medium, such as a copper or fiber optical cable; (2) Layer 2, the data link layer, which provides the functional and procedural means for the transfer of data between network entities and the detection and correction of errors that may occur in the physical layer; (3) Layer 3, the network layer, which provides the functional and procedural means for transferring variable length data sequences from a source host on one network to a destination host on a different network (in contrast to the data link layer which connects hosts within the same network), and performs network routing functions and sometimes fragmentation and reassembly; (4) Layer 4, the transport layer, which provides transparent transfer of data between end users, providing reliable data transfer services to the upper layers by controlling the reliability of a given link through flow control, segmentation/desegmentation, and error control; (5) Layer 5, the session layer, which controls the connections (interchanges) between computers, establishing, managing and terminating the connections between the local and remote applications; (6) Layer 6, the presentation layer, which establishes context between application layer entities, by which the higher-layer entities may use different syntax and semantics when the presentation service provides a mapping between them; and (7) Layer 7, the application layer, which interacts directly with the software applications that implement the communicating component.

Generic Stream Encapsulation (GSE) provides a data link layer protocol, which facilitates the transmission of data from packet oriented protocols (e.g., Internet protocol or IP) on top of a unidirectional physical layer protocol (e.g., DVB-S2, DVB-T2 and DVB-C2). GSE provides functions/characteristics, such as support for multi-protocol encapsulation (e.g., IPv4, IPv6, MPEG, ATM, Ethernet, VLANs, etc.), transparency to network layer functions (e.g., IP encryption and IP header compression), and support of several addressing modes, a mechanism for fragmenting IP datagrams or other network layer packets over baseband frames, and support for hardware and software filtering.

In a layered system, a unit of data that is specified in a protocol of a given layer (e.g., a “packet” at the network layer), and which includes protocol-control information and possibly user data of that layer, is commonly referred to as a “protocol data unit” or PDU. At the network layer, data is formatted into data packets (e.g., IP datagrams, Ethernet Frames, or other network layer packets).

In operation, communication component 202 receives source content 606 via communication channel 112. In particular, receiving component 212 receives source content 606 via communication channel 112.

Returning to FIG. 5, after the source content is received (S504), it is determined whether advertisement data is to be inserted (S506). In an example embodiment, decoder 204 determines whether advertisement data is to be inserted.

Returning to FIG. 3, if source content 606 is to have advertisement data inserted therein, decoder 204 will identify an advertisement placement opportunity start identifier, an advertisement space, an advertisement placement opportunity stop identifier. Alternatively, if source content 606 is not to have advertisement data inserted therein, decoder 204 will not identify an advertisement placement opportunity start identifier, an advertisement space, an advertisement placement opportunity stop identifier.

Returning to FIG. 5, if it is determined that no advertisement data is to be inserted (No at S506), then the data is transmitted (S518). In an example embodiment communication component 202 transmits the data.

For example, returning to FIG. 6A, if decoder 204 determines that no advertisement data is to be inserted into source content 606, then decoder 204 instructs AMC 602 to pass source content 606 to splicer 208. When splicer 208 receives source content 606 and no additional advertisement data to splice therein, splicer 208 passes source content 606 to encoder 210 for encoding.

MDC 216 creates a manifest for source content 606. Encoder 210 then generates an output stream 608 in the predetermined output encoding scheme, such as for example MPEG or ABR, wherein output stream 608 includes source content and the newly generated manifest. Encoder 210 provides output stream 608 to communication component 202.

Receiving component 212 receives output stream 608 from encoder 210 and provides output stream 608 to transmitting component 214. Transmitting component 214 than provides an output signal 610 based on output stream 608. In particular, transmitting component 214 may provide further processing to output stream 608, such as for example filtering and amplifying, to generate output signal 610.

Output signal 610 is then provided to the plurality of end user devices 110 by way of communication channel 116 and network 108. In this example embodiment, output signal 610 includes just a movie without any advertisement inserted therein.

Returning to FIG. 5, after the data is transmitted (S518), method 500 stops.

Returning to FIG. 5, if it is determined that advertisement data is to be inserted (Yes at S506), then advertisement data is obtained (S508). In an example embodiment AMC 602 obtains the advertisement data.

FIG. 6B illustrates an exploded view of content service provider 400 of FIG. 4 in an instance where the advertisement data is obtained.

In this example embodiment, AMC 602 operates in some situations in a manner similar to AMC 206 discussed above with reference to FIG. 2. In particular, in this example, after receiving component 212 receives source content 218 via communication channel 112, source content 218 is provided to decoder 204 so as to identify advertisement placement opportunity start identifier 304 and advertisement placement opportunity stop identifier 308. The decoded source content 218 is then provided to AMC 602.

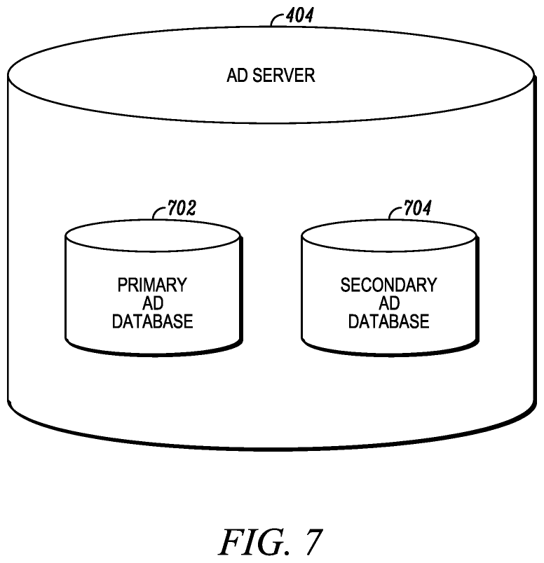

Returning to FIG. 4, AMC 602 retrieves advertisement data 612 from advertisement server 404. This will be described in greater detail with reference to FIG. 7.

FIG. 7 illustrates an exploded view of advertisement server 404 of content delivery system 400.

As shown in the figure, advertisement server 404 includes a primary advertisement database 702 and a secondary advertisement database 704.

In this example, primary advertisement database 702 and a secondary advertisement database 704 are illustrated as individual devices. However, in some embodiments, primary advertisement database 702 and secondary advertisement database 704 may be combined as a unitary device. Further, in some embodiments, at least one of primary advertisement database 702 and secondary advertisement database 704 may be implemented as a computer having tangible computer-readable media for carrying or having computer-executable instructions or data structures stored thereon.

Primary advertisement database 702 includes a plurality of advertisements for insertion into source content. Some advertisements in advertisement database 702 are conventional and similar in form to those discussed above with reference to prior art systems. Namely, such conventional advertisements atomic in the sense that they are intended to be played out in their respective entireties.

However, database 702 includes other, nested, advertisements that differ from the conventional advertisements. In particular, the nested advertisements include their own advertisement media portion, a nested advertisement placement opportunity start identifier, a nested advertisement space, a nested advertisement placement opportunity stop identifier and another advertisement media portion. Therefore, these nested advertisements are structured so as to have additional, nested, advertisements inserted therein, in accordance with aspects of this disclosure.

Returning to FIG. 6B, AMC 602 retrieves advertisement data 612 from advertisement server 404.

Returning to FIG. 5, after the advertisement data is obtained (S508), it is determined whether there is a secondary advertisement (S510). In an example embodiment, NAD component 604 determines whether there is a secondary advertisement.

For example, returning to FIG. 6B, NAD component 604 inspects advertisement data 612 and determines whether advertisement data 612 includes a nested advertisement placement opportunity start identifier, a nested advertisement space, a nested advertisement placement opportunity stop identifier. If advertisement data 612 does include a nested advertisement placement opportunity start identifier, a nested advertisement space, a nested advertisement placement opportunity stop identifier, then advertisement data 612 requires a secondary advertisement. If advertisement data 612 does not include a nested advertisement placement opportunity start identifier, a nested advertisement space, a nested advertisement placement opportunity stop identifier, then advertisement data 612 does not require a secondary advertisement and is therefore similar to the advertisements discussed above with reference to FIG. 3B.

Returning to FIG. 5, if it is determined that a secondary advertisement is not required (No at S510), then the advertisement is inserted (S512). For example, splicer 208 inserts the advertisement into the source content.

For example, returning to FIG. 6B, AMC 602 provides the decoded source content 218 and advertisement data 612 to splicer 208. Splicer 208 then splices, i.e. inserts, advertisement data 612 into the decoded content data.

Returning to FIG. 5, after the advertisement is inserted (S512), the stream is transmitted (S518). In an example embodiment, transmitting component 214 transmits the stream.

For example, returning to FIG. 6B, after splicer 208 has inserted advertisement data 612 into the stream of content, for example as discussed above with reference to FIGS. 3A-B, the modified stream is provided to encoder 210. MDC 216 generates a manifest that identifies the locations of each “chunk” of data, which in this example includes a first source media portion, advertisement portion corresponding to advertisement data 612 and second source media portion.

Encoder 210 then generates output stream 222 in the predetermined output encoding scheme. Encoder 210 provides output stream 222 to communication component 202.

Receiving component 212 receives output stream 222 from encoder 210 and provides output stream 222 to transmitting component 214. Transmitting component 214 than provides an output signal 224 based on output stream 222. Output signal 224 is then provided to the plurality of end user devices 110 by way of communication channel 116 and network 108.

Returning to FIG. 5, after the data is transmitted (S518), method 500 stops.

If it is determined that a secondary advertisement is required (Y at S510), then secondary advertisement data is obtained (S514). In an example embodiment, AMC 602 obtains the secondary advertisement data.

For example, returning to FIG. 6C, for purposes of discussion, let the primary advertisement data, which was retrieved from primary advertisement database 702 in advertisement server 404, be advertisement data 614. Further, let advertisement data 614 include a nested advertisement placement opportunity start identifier, a nested advertisement space, a nested advertisement placement opportunity stop identifier, thus indicating that advertisement data 614 requires a secondary advertisement.

In such a situation, NAD component 604 would detect nested advertisement placement opportunity start identifier, a nested advertisement space, a nested advertisement placement opportunity stop identifier and instruct AMC 602 to access secondary advertisement database 704 in advertisement server 404 to obtain a secondary advertisement.

AMC 602 will then access secondary advertisement database 704, as shown in FIG. 7, and obtain secondary advertisement data 616.

Returning to FIG. 5, after the secondary advertisement data is obtained (S514), the secondary advertisement data is inserted (S516) and the total advertising package is inserted into the source content data (S512). In an example embodiment, splicer 208 inserts the secondary advertisement data and the total advertising package.

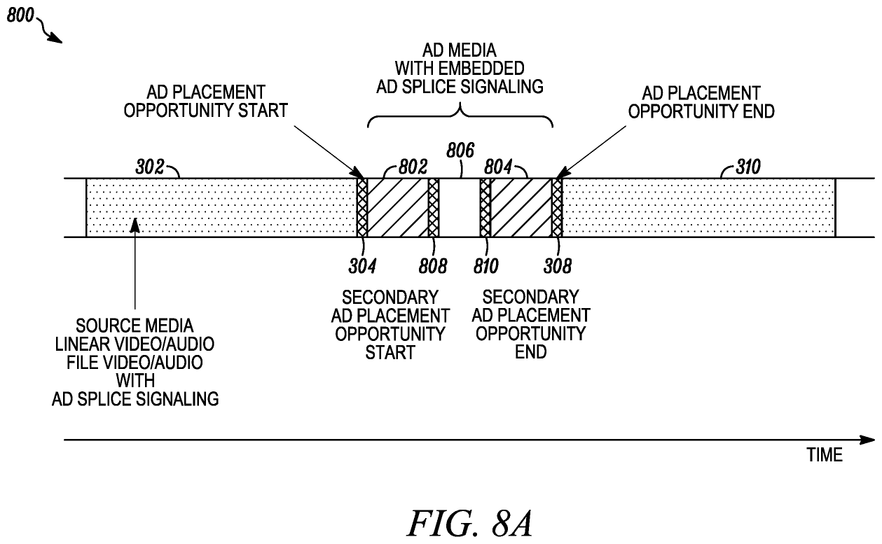

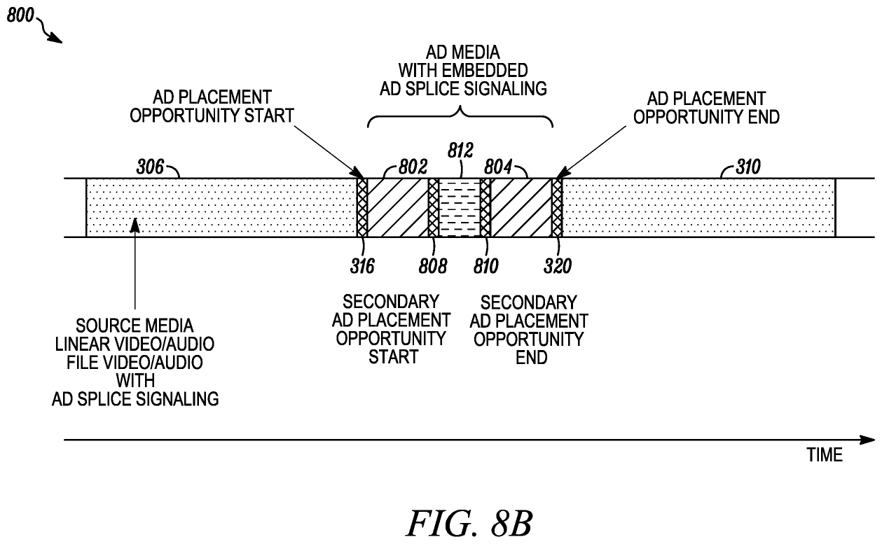

For example, returning to FIG. 6C, AMC 602 provides the decoded source content, advertisement data 614 and secondary advertisement data 616 to splicer 208. Splicer 208 then inserts secondary advertisement data 616 into advertisement data 614. This will be described in greater detail with reference to FIGS. 3 and 8A-B.

Again, as shown in the FIG. 3A, stream 300 includes source media portion 302, advertisement placement opportunity start identifier 304, advertisement space 306, advertisement placement opportunity stop identifier 308 and source media portion 310.

Advertisement placement opportunity start identifier 304 is a marker that will be used by splicer 208 to identify the start location within stream 300 for which advertisement data may be inserted. Similarly, advertisement placement opportunity stop identifier 308 is a marker that will be used by splicer 208 to identify the ending location within stream 300 for which advertisement data may be inserted.

Splicer 208 then inserts secondary advertisement data 616 (as advertisement data 220 in FIG. 3B) into stream 300 in between advertisement placement opportunity start identifier 304 and advertisement placement opportunity stop identifier 308.

However, in this situation, secondary advertisement data 616 includes a nested advertisement placement opportunity start identifier, a nested advertisement space, a nested advertisement placement opportunity stop identifier. This will be described with reference to FIGS. 8A-8B.

FIG. 8A illustrates a stream 800 of content, a primary advertisement and a space for secondary, or nested, advertisement data in accordance with aspects of the present disclosure.

As shown in the figure, stream 800 of content includes source media portion 302, advertisement placement opportunity start identifier 304, a primary advertisement portion 802, a nested advertisement placement opportunity start identifier 808, a nested advertisement space 806, a nested advertisement placement opportunity stop identifier 810, a primary advertisement portion 804, advertisement placement opportunity stop identifier 308 and source media portion 310.

In this example, primary advertisement portion 802 and primary advertisement portion 804 correspond to advertisement data 614.

Nested advertisement placement opportunity start identifier 808 is a marker that will be used by splicer 208 to identify the start location within advertisement data 614 for which secondary advertisement data 616 may be inserted. Similarly, nested advertisement placement opportunity stop identifier 810 is a marker that will be used by splicer 208 to identify the ending location within advertisement data 614 for which secondary advertisement data 616 may be inserted.

Nested advertisement space 806 is space within advertisement data 614 between nested advertisement placement opportunity start identifier 808 and nested advertisement placement opportunity stop identifier 810 into which secondary advertisement data 616 may be inserted.

After splicer 208 has inserted secondary advertisement data 616 into advertisement data 614, which is inserted into stream 300, the modified stream is provided to encoder 210. MDC 216 generates a manifest that identifies that locations of each “chunk” of data, which in this example, as shown in FIG. 8B, includes source media portion 302, advertisement portion 802, nested advertisement portion 812, advertisement portion 804 and source media portion 310.

Returning to FIG. 5, after the entire advertisement package is inserted (S512), the stream is transmitted (S518) and method 500 stops (S520).

In the non-limiting example embodiments discussed above, a single nested advertisement is inserted into a primary advertisement. However, it should be noted that any number of levels of nesting of advertisements may be implemented in accordance with aspects of the present invention.

In the non-limiting example embodiments discussed above, a single nested advertisement is inserted into a primary advertisement so as to have portions of the primary advertisement on both sides of the nested advertisement. However, it should be noted that the nested advertisement may be disposed at the beginning or the end of the primary advertisement, in accordance with aspects of the present invention.

In the non-limiting example embodiments discussed above, an advertisement is used for purposes of discussion only. It should be noted that any type of content may be nested within any other type of content, in accordance with aspects of the present invention.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A system for use with a source content provider, a first database and a second database, the source content provider being operable to provide source content data having a placement opportunity start identifier for an insert position for primary advertisement data and a placement opportunity stop identifier for an end position for the primary advertisement data, the first database having first advertisement data and second advertisement data, one of the first advertisement data and the second advertisement data to be inserted between the insert position and the end position, the first advertisement data having a second placement opportunity start identifier for a second insert position for nested advertisement data and a second placement opportunity stop identifier for a second end position for the nested advertisement data, the second database having the third advertisement data to be inserted between the second insert position and the second end position, said system comprising:
a communication component operable to receive the source content data;
an advertisement management component operable to obtain one of the first advertisement data and the second advertisement data as obtained advertisement data;
a nested advertisement determining component operable to determine whether the obtained advertisement data includes the second placement opportunity start identifier and the second placement opportunity stop identifier;
an splicer; and
a manifest delivery controller operable to assemble a manifest,
wherein when said nested advertisement determining component determines that the obtained advertisement data includes the second placement opportunity start identifier and the second placement opportunity stop identifier, said advertisement management component is further operable to obtain the third advertisement data as nested advertisement data,
wherein said splicer is operable to generate output data comprising the source content data, the first advertisement data, the third advertisement data and the manifest, and
wherein the manifest includes information indicating a first starting point of the first advertisement data and second starting point of the third advertisement data within the output data.

2. The system of claim 1, further comprising an encoder operable to encode the output data.

3. The system of claim 2, wherein the encoder is operable to encode the output data as an MPEG transport stream.

4. The system of claim 3, wherein said advertisement management component, said nested advertisement determining component and said splicer are a unitary device.

5. The system of claim 2, wherein the encoder is operable to encode the output data as an adaptive bitrate linear stream.

6. The system of claim 5, wherein said advertisement management component, said nested advertisement determining component and said splicer are a unitary device.

7. The system of claim 1, wherein said advertisement management component, said nested advertisement determining component and said splicer are a unitary device.

8. A method comprising:
receiving, via a communication component and from a source content provider, source content data having a placement opportunity start identifier for an insert position for primary advertisement data and a placement opportunity stop identifier for an end position for the primary advertisement data;
obtaining, via an advertisement management component and from a first database, one of first advertisement data and second advertisement data as obtained advertisement data to be inserted between the insert position and the end position, the first advertisement data having a second placement opportunity start identifier for a second insert position for nested advertisement data and a second placement opportunity stop identifier for a second end position for the nested advertisement data;
obtaining, via the advertisement management component and from a second database, third advertisement data;
determining, via a nested advertisement determining component, whether the obtained advertisement data includes the second placement opportunity start identifier and the second placement opportunity stop identifier;
assembling, via a manifest delivery controller, a manifest;
obtaining, via the advertisement management component when the nested advertisement determining component determines that the obtained advertisement data includes the second placement opportunity start identifier and the second placement opportunity stop identifier, the third advertisement data from the second database as nested advertisement data; and
generating, via a splicer, output data comprising the source content data, the first advertisement data, the third advertisement data and the manifest,
wherein the manifest includes information indicating a first starting point of the first advertisement data and second starting point of the third advertisement data within the output data.

9. The method of claim 8, further comprising encoding, via an encoder, the output data.

10. The method of claim 9, wherein said encoding, via the encoder, the output data comprises encoding the output data as an MPEG transport stream.

11. The method of claim 10, wherein the advertisement management component, the nested advertisement determining component and the splicer are a unitary device.

12. The method of claim 9, wherein said encoding, via the encoder, the output data comprises encoding the output data as an adaptive bitrate linear stream.

13. The method of claim 12, wherein the advertisement management component, the nested advertisement determining component and the splicer are a unitary device.

14. The method of claim 8, wherein the advertisement management component, the nested advertisement determining component and the splicer are a unitary device.

15. A non-transitory, tangible, computer-readable media having computer-readable instructions stored thereon, the computer-readable instructions being capable of being read by a computer and being capable of instructing the computer to perform the method comprising:
receiving, via a communication component and from a source content provider, source content data having a placement opportunity start identifier for an insert position for primary advertisement data and a placement opportunity stop identifier for an end position for the primary advertisement data;
obtaining, via an advertisement management component and from a first database, one of first advertisement data and second advertisement data as obtained advertisement data to be inserted between the insert position and the end position, the first advertisement data having a second placement opportunity start identifier for a second insert position for nested advertisement data and a second placement opportunity stop identifier for a second end position for the nested advertisement data;
obtaining, via the advertisement management component and from a second database, third advertisement data;
determining, via a nested advertisement determining component, whether the obtained advertisement data includes the second placement opportunity start identifier and the second placement opportunity stop identifier;
assembling, via a manifest delivery controller, a manifest;
obtaining, via the advertisement management component when the nested advertisement determining component determines that the obtained advertisement data includes the second placement opportunity start identifier and the second placement opportunity stop identifier, the third advertisement data from the second database as nested advertisement data; and
generating, via a splicer, output data comprising the source content data, the first advertisement data, the third advertisement data and the manifest,
wherein the manifest includes information indicating a first starting point of the first advertisement data and second starting point of the third advertisement data within the output data.

16. The non-transitory, tangible, computer-readable media of claim 15, the computer-readable instructions being capable of instructing the computer to perform the method further comprising encoding, via an encoder, the output data.

17. The non-transitory, tangible, computer-readable media of claim 16, the computer-readable instructions being capable of instructing the computer to perform the method wherein said encoding, via the encoder, the output data comprises encoding the output data as an MPEG transport stream.

18. The non-transitory, tangible, computer-readable media of claim 17, the computer-readable instructions being capable of instructing the computer to perform the method wherein the advertisement management component, the nested advertisement determining component and the splicer are a unitary device.

19. The non-transitory, tangible, computer-readable media of claim 16, the computer-readable instructions being capable of instructing the computer to perform the method wherein said encoding, via the encoder, the output data comprises encoding the output data as an adaptive bitrate linear stream.

20. The non-transitory, tangible, computer-readable media of claim 19, the computer-readable instructions being capable of instructing the computer to perform the method wherein the advertisement management component, the nested advertisement determining component and the splicer are a unitary device.
